(19) United States
(12) Patent Application Publication
(10) Pub. No.: US 2008/0267214 A1
(43) Pub. Date: Oct. 30, 2008

(54) Universal datagram protocol (UDP) port based broadcast filtering

(76) Inventor: Mikko Jaakkola, Lempaala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/796,620

(22) Filed: Apr. 27, 2007

(51) Int. Cl. H04J 3/16

(52) U.S. Cl. 370/468

(57) ABSTRACT

A new and unique method or apparatus for power savings in a node, point, terminal or device in a wireless communications technology, such as a wireless local area network (WLAN), Worldwide Interoperability for Microwave Access Forum (WiMAX), Ultra wide band (UWB), or other suitable network, featuring receiving in a radio modem chipset information indicating that a host processor wants the radio modem chipset to filter out unwanted data packets; and filtering one or more unwanted data packets in the radio modem chipset without passing them to the host processor based on the information received for providing power savings in a node, point, terminal or device that forms part of a wireless communications technology, including a wireless local area network or other suitable network.

### BACKGROUND OF THE INVENTION

1. Field of Invention

The present invention relates to a wireless communications technology, such as, for example, a wireless local area network (WLAN), Worldwide Interoperability for Microwave Access Forum (WiMAX), Ultra wide-band (UWB), or any other suitable communications technology like for example Bluetooth (BT).

Moreover, the present invention also relates to power savings in a wireless short-range communication environment, such as, for example the WLAN environment, and provides a method and system for reducing power consumption in e.g. WLAN host processor by providing means to receive in a WLAN radio modem chipset information about whether a host processor wants the radio modem chipset to filter out unwanted data packets without forwarding them; and filter one or more unwanted data packets in the chipset without passing them to the host processor based on the information received for providing power savings and minor performance improvements in a node, point, terminal or device that forms part of such wireless communications technology.

Moreover still, the present invention also relates to wireless short-range communication, such as, for example WLAN communication, and more particularly to a method and system for enabling power savings in a short-range communication terminal, such as, for example a WLAN terminal by way of providing means for the WLAN radio modem chipset to filter out unwanted data packets without forwarding them to a WLAN host subsystem especially in a two-part WLAN radio module implementation.

2. Description of Related Art

Typical LAN networks having Windows (and other desktop clients) are transmitting periodic broadcast traffic due to various application protocols that rely on the broadcast behaviour. There are many broadcast based protocols (e.g. NetBIOS) that transmit data to the network either in a periodic manner or as a normal data transmit procedure. Broadcast traffic causes wireless devices belonging to the network, such as, for example a WLAN mobile device to wake-up periodically just to make TCP/IP check that it does not need the information. All this processing is in many cases unnecessary (unless there happens to be a service using the broadcast traffic). Also, the larger the number of PCs connected to the network, the more unsolicited broadcast traffic there will be and the longer the times the mobile device is required to be awake. In some hotspot type of networks, packet frequency can be up to 200 Hz, which basically means that wireless devices, such as, for example WLAN devices connected to the network are practically awake all the time, thus the processor will never really enter into a deep-sleep.

Moreover, this basic problem is also specific to a wireless terminal having a two-part WLAN module implementation with a WLAN radio module and a host subsystem, where the WLAN radio module consists of a WLAN radio modem chipset that is made thin to ensure that costs of such radio modem chipset is kept low. The WLAN host subsystem is for controlling and directing the operations of the thin WLAN radio modem chipset so basically all relevant information needs to be forwarded to the WLAN host subsystem, which creates a problem in that it is very difficult to keep the WLAN host subsystem in a power saving state in WLAN network environments where the WLAN terminal receives various unsolicited broadcast traffic when associated with the network. In view of this, the basic problem in the art also relates to unsolicited broadcast traffic that keeps such a WLAN host subsystem in an active state as the devices in the network are obligated to receive the broadcast messages and that way causes unnecessarily high power consumption for the wireless terminal. The reason why this is problematic is based on the fundamental need to keep the WLAN radio modem chipset thin and keep most of the control information on the WLAN host subsystem. For example, in most cases TCP/IP is a host process service and in case of broadcast traffic the needed processing must take place at host processor node. However, as the WLAN radio modem chipset is made thin, all received information is passed to the WLAN host subsystem that has to be kept awake and unnecessary power is consumed.

In one part radio module implementations where the WLAN radio modem operates as a single entity having also the host side integrated in the radio modem, it is known that that a WLAN radio modem can do some filtering out of unwanted data. Moreover, it is known that ARP filtering at MAC-level can reduce the amount of wake-up. Also multicast traffic filtering can be done at MAC-address bases.

In view of this, there is a need in the art for a method, system or technique in which a radio modem chipset can filter out unwanted data packets without forwarding them to the host processor in a wireless terminal having two-part WLAN radio module implementation.

### SUMMARY OF THE INVENTION

The present invention provides a new and unique method and apparatus for power savings in a node, point, terminal or device in a wireless communications technology, such as a wireless local area network (WLAN), WiMAX, UWB, or other suitable network, that features receiving in a radio modem chipset information indicating that a host processor wants the radio modem chipset to filter out unwanted data packets; and filtering one or more unwanted data packets in the radio modem chipset without passing them to the host processor based on the received information.

In some embodiments according to the present invention, the WLAN chipset may be configured to filter all unwanted universal datagram protocol (UDP) broadcast traffic (all IP based broadcast traffic are always UDP based) using the UDP port-information provided by the WLAN subsystem. The WLAN subsystem be configured to acquire the information from the OS socket layer and pass it to the WLAN chipset.

In operation, the radio modem chipset may be configured to receive unwanted port information, such as unwanted UDP port-information, from the host processor, and filters out data coming through such ports. For example, the radio modem chipset can be configured to match a pattern associated with ports of the unwanted data packets in relation to information contained in a header of received data packets so as to filter data packets from unwanted ports.

The radio modem chipset and the host processor may be configured to form part of a two-part wireless communication module implementation, or other suitable two-part module implementation either now known or later developed in the future.

The information may form part of signalling between the radio modem chipset and the host processor for indicating a request for filtering incoming broadcast packets by the radio modem chipset, and may also form part of universal datagram protocol (UDP) port-information located in a UDP-header.

The unwanted data packets may include unwanted universal datagram protocol (UDP) broadcast traffic using UDP port-information provided by the host processor. The transmissions received by the radio modem chipset may include broadcast or multicast type of information that forms a part of the communication in the network.

The host processor may be configured to acquire the information from a socket layer or other suitable layer either now known or later developed in the future and pass it to the radio modem chipset.

The basic idea of the case is to provide signaling between a WLAN host subsystem and a WLAN radio modem chipset for indicating a request for filtering unwanted incoming broadcast packets by the WLAN radio modem chipset.

According to some embodiments of the present invention, the WLAN radio modem chipset is configured to filter all unwanted UDP broadcast traffic (all Internet Protocol (IP) based broadcast traffic is always UDP based) using the UDP port-information provided by the WLAN host subsystem. The WLAN host subsystem is configured to acquire the information from the OS socket layer and pass it to the WLAN modem chipset.

According to some embodiments of the present invention, the WLAN radio modem chipset is configured with some basic means to filter out unwanted UDP broadcast packets without passing the data to the WLAN host subsystem based on UDP port information provided by the WLAN host subsystem. The actual implementation requires some signaling between the WLAN host subsystem and the WLAN radio modem chipset, wherein the radio modem chipset is also provided with some additional intelligence to react based on the information provided by the WLAN host subsystem so that the modem chipset is capable of filtering data coming through “unwanted” UDP ports.

In effect, some embodiments of the present invention provide a basic technique to reduce power-consumption of an idle WLAN enabled device that is connected to a network by reducing packet delivery to the host processor. It can also slightly improve the performance of the active node by reducing the need for processing unnecessary data.

The scope of the invention may also include a node, point, terminal or device in such a wireless communications technology, including a wireless local area network (WLAN), WiMAX, UWB, or other suitable network, such as IEEE 802.XX technologies having a similar two-part implementation. The node, point, terminal or device may include a station (STA) or other suitable network node, point, terminal or device in the WLAN. Moreover, the scope of the invention may also include a WLAN radio modem chipset for such a node, point, terminal or device in such a wireless local area network (WLAN) or other suitable network, featuring a first chipset module configured for communicating with a host processor for receiving information indicating that the host processor wants to filter out unwanted data packets, and a second chipset module coupled with the first chipset module and configured for filtering one or more unwanted data packets without passing them to the host processor based on the information received by the first chipset module, as well as a host processor featuring one or more modules configured for generating information about unwanted data packets that needs to be filtered out by a radio modem chipset without forwarding them to the host processor, and an interface for providing the information to the radio modem chipset, as well as a computer program product with a program code, which program code is stored on a machine readable carrier, for carrying out the method according to some embodiments of the present invention. The method may also feature implementing the method via a computer program running in a processor, controller or other suitable module in one or more network nodes, points, terminals or elements in the wireless LAN network.

In summary, in some embodiments of the present invention power savings is provided with the “two-part WLAN radio module” implementation, wherein the host processor is configured to signal “unwanted” UDP-port information to WLAN radio modem chipset that is configured to use the information for filtering out data coming through the identified ports.

Some embodiments of the present invention allow power-savings in a mobile device using WLAN by providing a technique for the WLAN subsystem to optimize how it wakes up a sleeping host processor or system. The technique is particularly aimed at reducing the penalty that processing the broadcast/multicast and keep-alive traffic causes in the host processor by forcing the host processor to wake up from a deep-sleep. The optimization is carried out by filtering unwanted data packets and not forwarding them to the host processor.

Some embodiments of the present invention reduce MIPS requirements from the host for processing unnecessary traffic, and reduce the total power-consumption as the host is not going to be woken up by unnecessary broadcast traffic. The filtering technique according to some embodiments of the present invention also does not restrict any functionality from the mobile device as in practice the operation would be 100% transparent.

### BRIEF DESCRIPTION OF THE DRAWING

The drawing includes the following Figures, which are not necessarily drawn to scale:

FIG. 1 shows typical parts of an IEEE 802.11 WLAN system according to some embodiments of the present invention.

FIGS. 2a and 2b show diagrams of the Universal Mobile Telecommunications System (UMTS) packet network architecture according to some embodiments of the present invention.

FIG. 3 shows a WLAN enabled device that forms part of the WLAN shown in FIG. 1 according to some embodiments of the present invention.

FIG. 4 shows a WLAN chipset that forms part of the WLAN enabled device shown in FIG. 3 according to some embodiments of the present invention.

FIG. 5a shows a flowchart of the basic steps of the method for the chipset according to some embodiments of the present invention.

FIG. 5b shows a flowchart of the basic steps of the method for the host processor according to some embodiments of the present invention.

FIG. 6 shows a diagram of a simplified WLAN device system according to some embodiments of the present invention.

FIG. 7 shows a diagram of a modified WLAN device system according to some embodiments of the present invention.

### DETAILED DESCRIPTION OF THE INVENTION

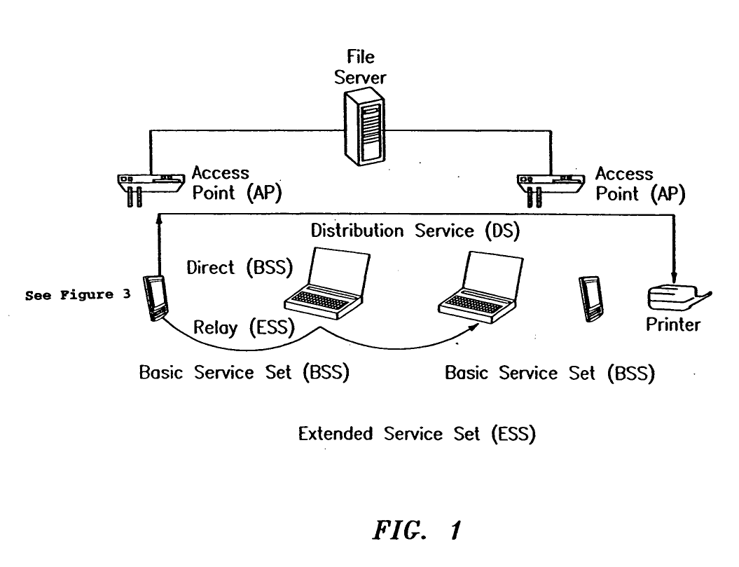

FIG. 1 shows, by way of example, typical parts of an IEEE 802.11 WLAN system, according to some embodiments of the present invention, and provides for communications between communications equipment such as mobile and secondary devices including personal digital assistants (PDAs), laptops and printers, etc. The WLAN system may be connected to a wired LAN system that allows wireless devices to access information and files on a file server or other suitable device or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

Although the present invention is described in relation to a wireless local area network (WLAN), the present invention is also applicable to other suitable wireless communications technologies, such as, for example, WiMAX, UWB and/or BT technologies, as well as other suitable network technologies either now known or later developed in the future.

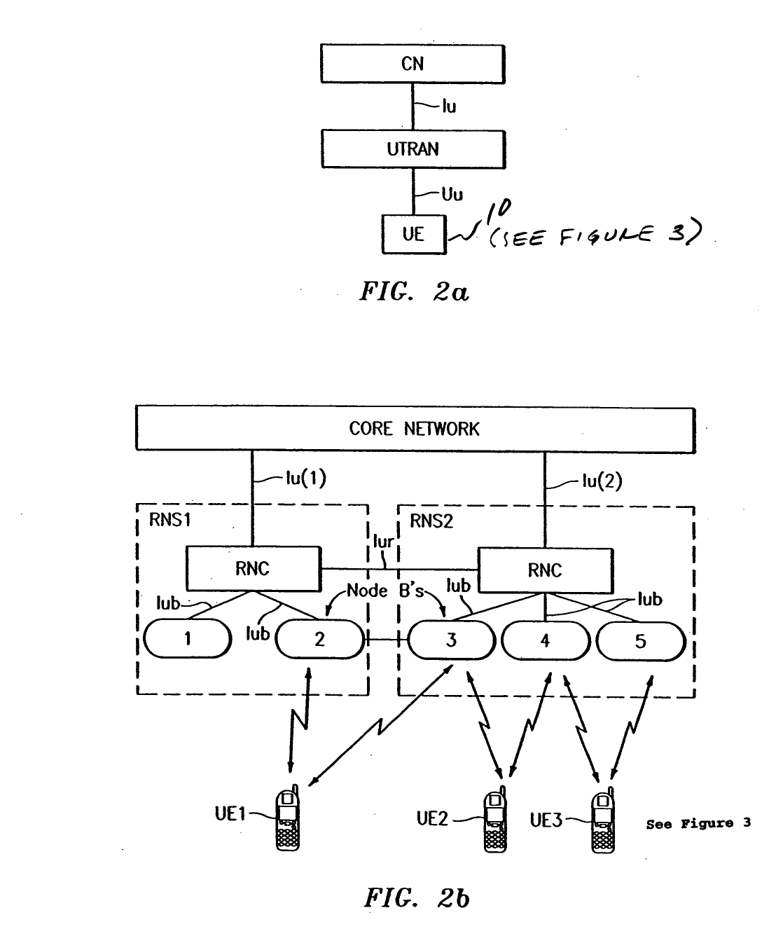

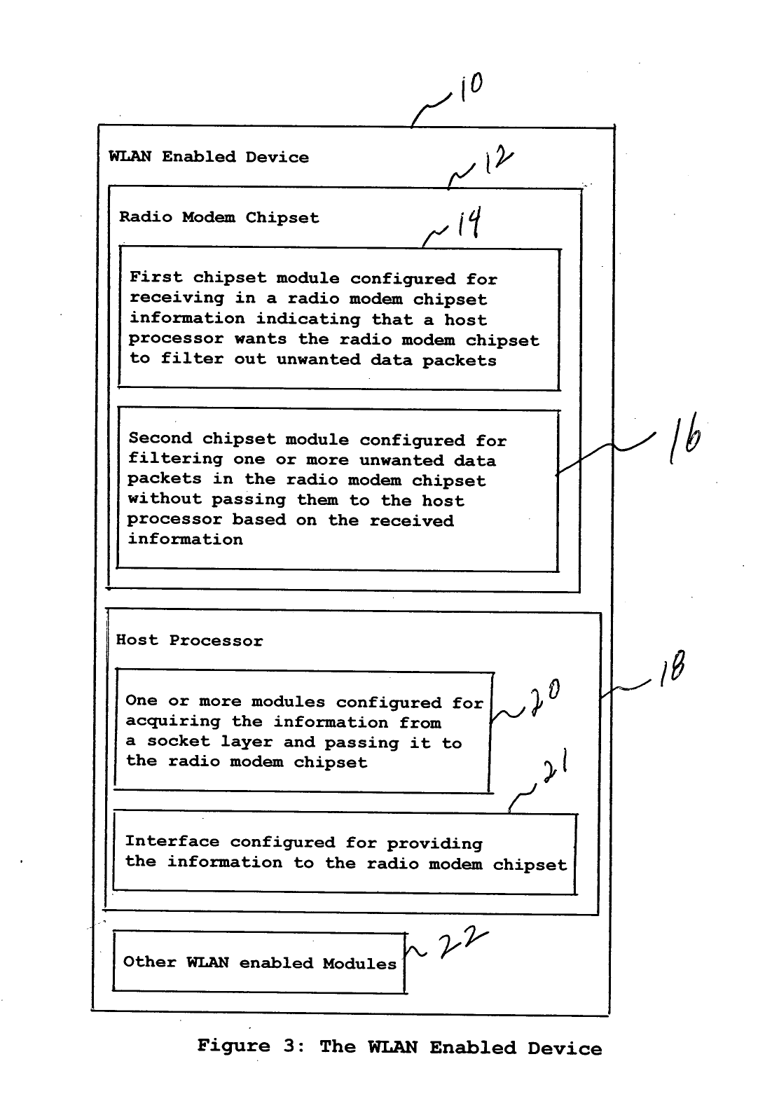

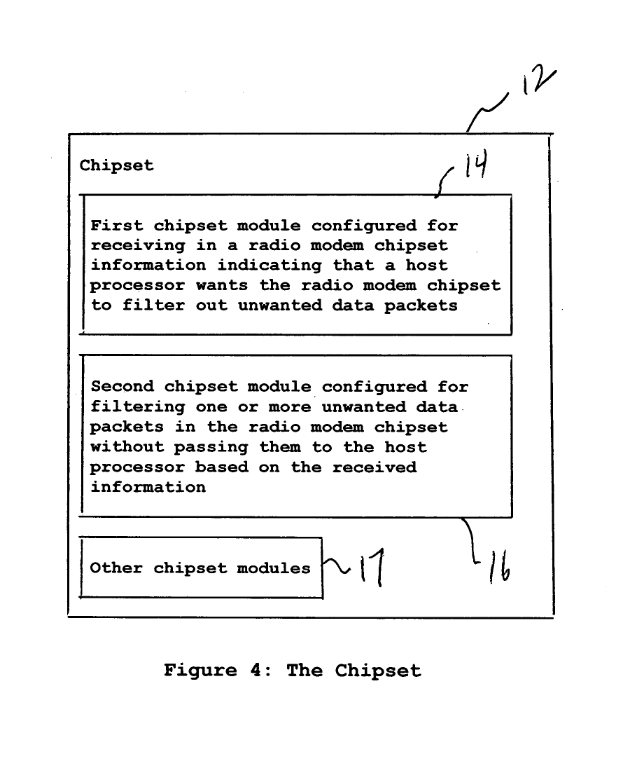

In particular, FIG. 3 shows a node, point, terminal or device in the form of a WLAN enabled device generally indicated 10 according to a non-limiting embodiment of the present invention for a wireless local area network (WLAN) or other suitable network such as that shown in FIG. 1, as well as FIGS. 2a and/or 2b consistent with that discussed below. The WLAN enabled device 10 has a WLAN radio modem chipset 12 including a first chipset module 14 (see FIG. 4) configured for communicating with a host processor receiving information indicating that the host processor wants to filter out unwanted data packets, and a second chipset module 16 coupled with the first chipset module and configured for filtering one or more unwanted data packets without passing them to the host processor based on the information received by the first chipset module for providing power savings in the WLAN enable device 10. The present invention is implemented using an exchange of signaling between the WLAN radio modem chipset 12 and the host processor 14, so that the host processor 14 can signal such information to the WLAN radio modem chipset 12, and the WLAN radio modem chipset 12 can operate or respond accordingly, consistent with that shown and described herein. The WLAN enabled device 10 may take the form of a station (STA), or other suitable node, point, terminal or device either now known or later developed in the future for operating in such a wireless local area network (WLAN) or other suitable network such as that shown in FIGS. 1, 2a and/or 2b. In addition, the data packets may be received by the WLAN enabled device 10 from a network or other device (not shown). The scope of the invention is not intended to be limited to the type or kind of data packets being received by the WLAN enabled device 10, or from where the data packets are received.

The WLAN enabled device 10 also has a host processor 18 having one or more modules 20 configured for generating information about unwanted data packets that need to be filtered out by such a radio modem chipset 12 without forwarding them to the host processor; and an interface 21 configured for providing the information to the radio modem chipset 12.

The WLAN enabled device 10 may also have other WLAN enabled modules 22 that are known in the art and do not form part of the underlying invention disclosed herein, and thus are not described in detail herein.

FIG. 4 shows, by way of example, the WLAN radio modem chipset 12 in further detail, including the first chipset module 14 and the second chipset module 16, consistent with that described above, and other chipset modules 17 that are known in the art and do not form part of the underlying invention disclosed herein, including e.g. a baseband module, a MAC module, a host interface module, and thus are not described in detail herein.

In particular, the overall technique according to some embodiments of the present invention may be implemented, by way of example, as follows:

The WLAN host subsystem 18 acquires all the UDP ports from an OS socket-layer (not shown) that have a bound socket in them. All IP-broadcast traffic is UDP type and just by having a pattern matching in place at the WLAN radio modem chipset 12, the WLAN chipset 12 can filter unwanted UDP ports without having to pass the packet to the host's IP-stack.

UDP port info is in a static location at the UDP-header so with minimal parsing, the WLAN radio modem chipset 12 can locate the port-info based on the information. In particular, the WLAN radio modem chipset 12 parses the WLAN-header to see if the received frame is a multicast frame (also broadcast is one type of multicast frame) and if so then it looks up the frame type from the IEEE 802 SNAP-header. If the packet type is IP, then the right offset of the UDP port information can be acquired by skipping the IP-header by using IP-header length and then parsing UDP port info from the UDP-header (the second 16-byte value; bytes 3-4 of the header). If the received packet has a port number, which has been registered to the WLAN chipset 12, then it passes the frame to the WLAN host subsystem 18. This practice will ensure that only needed frames are waking up the WLAN host 18 and using the valuable processor cycles.

Moreover, consistent with that described above, it is known in the art that all 802.11 frames typically have a SNAP frame that contains among other things a Type-field, which describes the frametype that can, for example, be found at end of the Ethernettype II header; and that if the type of the data is IPv4 (0x0800), then there will be an IP-header right after the SNAP header. A person skilled in the art at the time of this invention would appreciate that the data configuration of such a SNAP frame, IP-header, Internet Protocol version 4 (IPv4), User Data Protocol (UDP), etc. are all very known in the art, well described in technical literature, including articles on the Wikipedia website, and not needed to be described further in detail herein for the purpose of understanding the present invention. See http://en.wikipedia.org/wiki/IPv4 or user_datagram_protocol, by way of example. In particular, the Header length field in the IP-header gives the exact length of the IP-header as it is a variable length header-structure, and the Protocol-field in the IP-header will provide information about what kind of IP-header this is—i.e. UDP or TCP. If the frame turns out to be a UDP header, then the UDP-frame has been placed right after the IP-header. Based on this understanding, according to some embodiments of the present invention, one can match against the Destination Port field to see if this datagram is a wanted or unwanted.

The port registration is performed in such a way that the WLAN host subsystem 18 acquires socket bind information and puts things into a list. Preferably, the WLAN host subsystem should register a notification to itself when socket layer ports have been added or deleted from the socket-layer port set.

The scope of the invention is intended to include expanding this implementation to any other kind of protocols using such mapping mechanism. This method is also applicable for other 802 technologies such as 802.16e (Wimax) and etc.

### Implementation of the Functionality of Modules 14, 16 and 20

By way of example, and consistent with that described herein, the functionality of the modules 14, 16 and 20 may be configured and implemented using hardware, software, firmware, or a combination thereof, although the scope of the invention is not intended to be limited to any particular embodiment thereof. In a typical software implementation, the modules 14, 16 and 20 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 14 and 16, or the module 20 being configured as stand alone modules, as shown, or being configured in the combination with other circuitry for implementing another module.

The other WLAN enabled modules 22 and chipset modules 17 may also include other modules, circuits, devices that do not form part of the underlying invention per se. The functionality of the other modules, circuits, device that do not form part of the underlying invention are known in the art and are not described in detail herein.

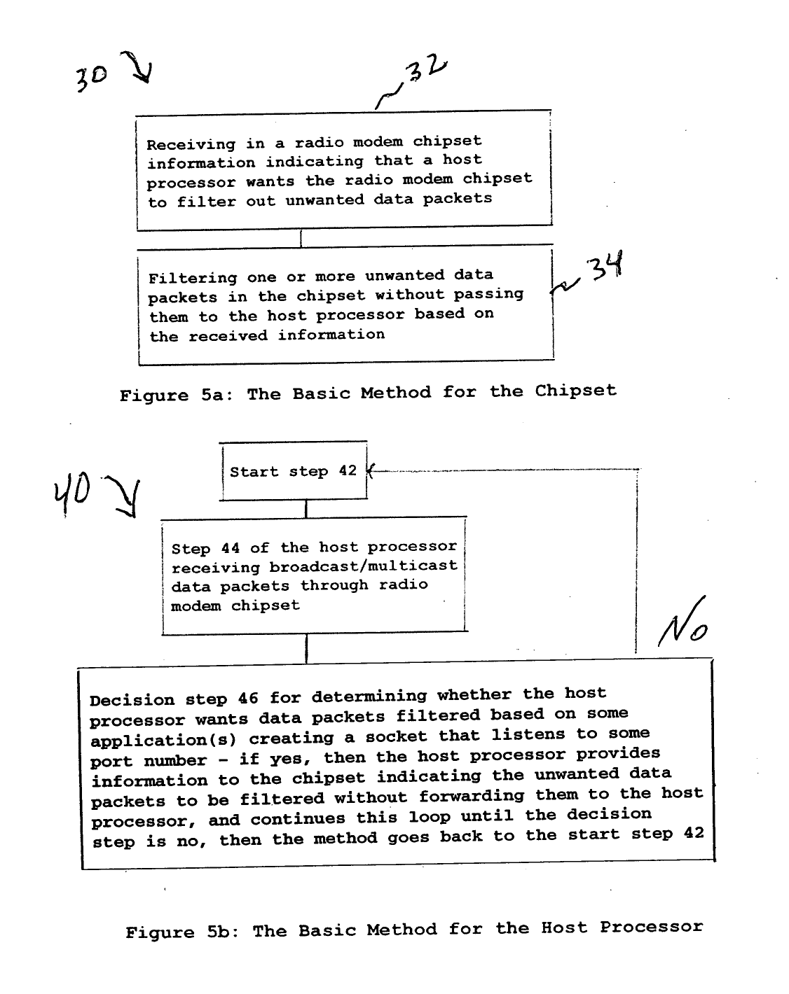

### FIGS. 5a and 5b

FIG. 5a shows a basic flowchart 30 of the method for the chipset according to some embodiments of the present invention, having a step 32 of receiving in a radio modem chipset information indicating that a host processor wants the radio modem chipset to filter out unwanted data packets, and step 34 of filtering one or more unwanted data packets in the radio modem chipset without passing them to the host processor based on the received information for providing power savings and performance improvements in e.g. a WLAN enable terminal, or other suitable node, point or device that forms part of such a wireless communications technology, including a wireless local area network or other suitable network set forth herein.

FIG. 5b shows a basic flowchart 40 of the method for the host processor according to some embodiments of the present invention, having a start step 42; a step 44 of the host processor receiving broadcast/multicast data packets through radio modem chipset; and a decision step 46 for determining whether the host processor wants data packets filtered based on some applications creating a socket that listens to some port number—if yes, then the host processor provides information to the chipset indicating the unwanted data packets to be filtered without forwarding them to the host processor, and continues this loop until the decision step is no, then the method goes back to the start step 42.

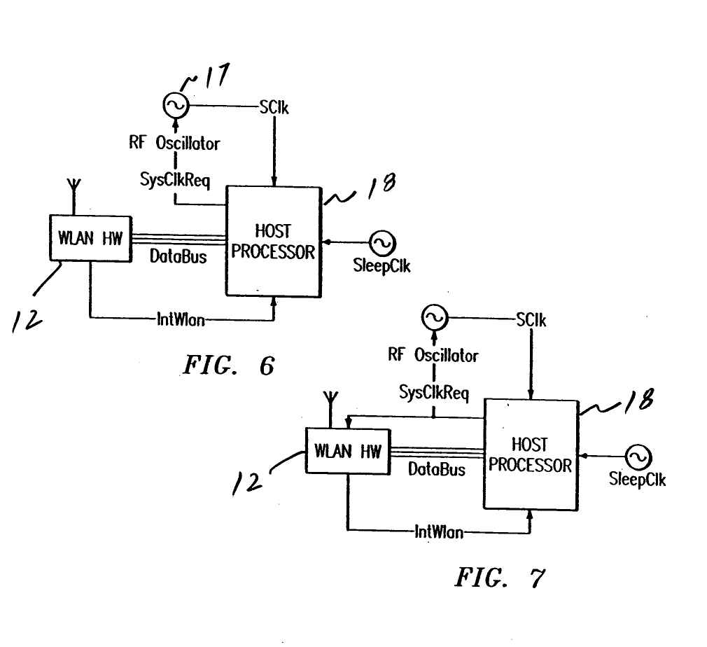

### FIGS. 6-7: Simplified Examples of WLAN Systems

FIG. 6 shows an exemplary and simplified WLAN device system having a two-part module implementation. In operation, when the host processor 18 is in a sleep mode only a sleep clock (SleepClk) is on so that the host processor 18 can wake itself up when external peripherals want to wake system up. For example, when the WLAN radio modem chipset (HW 12 on the figure) wants to wake the system up, it first raises the interrupt line (IntWlan) line, which causes the host processor 18 to enable the system clock request (SysClkReq) to get the main host processor 18 up running once the RF oscillator 17 is stabilized. Once the host processor 18 is fully ready, it processes the interrupt and pulls data from the WLAN HW 12. After processing, the host processor 18 will disable the clock request signal and enter back into a deep-sleep.

Alternatively, FIG. 7 shows a modified system that is similar to the system shown in FIG. 6, with an exception that the SysClkReq is connected to WLAN HW via general purpose I/O pin so that it can detect the state of the host processor's main clock and use the info to adjust its behaviour. The scope of the invention is intended to include implementation is such a system, as well as other such systems either now known or later developed in the future.

### The WLAN Chipset

The present invention may also take the form of the WLAN chipset for such a node, point, terminal or device in a wireless local area network (WLAN) or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

### FIGS. 2a and 2b: The UMTS Packet Network Architecture

The scope of the invention is also intended to include implementing the same in relation to a Universal Mobile Telecommunications System (UMTS) packet network architecture, such as that shown in FIGS. 2a and 2b, which includes diagrams of the UMTS packet network architecture.

In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface, and would operate in a manner consistent with that shown and described above, including that shown in FIG. 3.

FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCS. For instance, a UE1 in FIG. 2b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 2a and 2b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2.

### WLAN Technology and Other System Design Issues

The reader is also referred to patent application Ser. No. 11/402,285, filed 10 Apr. 2006 which describes a two-part WLAN radio module implementation, and is hereby incorporated in its entirety.

Moreover, a person skilled in the art would recognize and understand the WLAN technology and system design issues regarding the host wake-up challenges that are needed to fully appreciate the present invention. Moreover, a person skilled in the art would also have a recognition and understanding of TCP/IP and especially UDP and broadcast related functionality and enabling mechanisms that are helpful in appreciating the same, as well as basic knowledge of Posix type of socket-layer API to help to understand how important information is based to socket-layers.

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method comprising:
receiving in a radio modem chipset information indicating that a host processor wants the radio modem chipset to filter out unwanted data packets; and
filtering one or more unwanted data packets in the chipset without passing them to the host processor based on the received information.

2. A method according to claim 1, wherein the radio modem chipset is configured to receives unwanted port information, such as unwanted universal datagram protocol port-information, from the host processor, and filters out data coming through such ports.

3. A method according to claim 1, wherein the radio modem chipset and the host processor are configured to form part of a two-part wireless communication module implementation.

4. A method according to claim 1, wherein the information forms part of signalling between the radio modem chipset and the host processor for indicating a request for filtering incoming broadcast packets by the chipset.

5. A method according to claim 1, wherein the unwanted data packets include unwanted universal datagram protocol broadcast traffic using universal datagram protocol port-information provided by the host processor.

6. A method according to claim 1, wherein the host processor is configured to acquires the information from a socket layer and passes it to the radio modem chipset.

7. A method according to claim 1, wherein the radio modem chipset is configured to matches a pattern associated with ports of the unwanted data packets in relation to information contained in a header of received data packets so as to filter data packets from unwanted ports.

8. A method according to claim 1, wherein the information forms part of universal datagram protocol port-information located in a universal datagram protocol header.

9. A node, point, terminal or device comprising:
a radio modem chipset including:
a first chipset module configured for communicating with a host processor for receiving information indicating that the host processor wants to filter out unwanted data packets; and
a second chipset module coupled with the first chipset module and configured for filtering one or more unwanted data packets without passing them to the host processor based on the information received by the first chipset module.

10. A node, point, terminal or device according to claim 9, wherein the first chipset module is configured to receives unwanted port information, such as unwanted universal datagram protocol port-information, from the host processor, and the second chipset module is configured to filters out data coming through such ports.

11. A node, point, terminal or device according to claim 9, wherein the radio modem chipset and the host processor are configured to form part of a two-part wireless communication module implementation.

12. A node, point, terminal or device according to claim 11, wherein the wireless communication module includes a wireless local area network radio modem chipset and a wireless local area network host subsystem and operates according to one or more wireless local area network communication protocols.

13. A node, point, terminal or device according to claim 9, wherein the information forms part of signalling between the radio modem chipset and the host processor for indicating a request for filtering incoming broadcast packets by the chipset.

14. A node, point, terminal or device according to claim 9, wherein the unwanted data packets include unwanted universal datagram protocol broadcast traffic using universal datagram protocol port-information provided by the host processor.

15. A node, point, terminal or device according to claim 9, wherein the host processor is configured to acquires the information from a socket layer and passes it to the chipset.

16. A node, point, terminal or device according to claim 9, wherein either the first or second chipset module is configured to matches a pattern associated with ports of the unwanted data packets in relation to information contained in a header of received data packets so as to filter data packets from unwanted ports.

17. A node, point, terminal or device according to claim 9, wherein the information forms part of universal datagram protocol port-information located in a universal datagram protocol header.

18. A node, point, terminal or device according to claim 9, wherein the node, point, terminal or device is a station, or other suitable network node or terminal in the wireless communications technology.

19. A chipset comprising:
a first chipset module configured for receiving information indicating that a host processor wants to filter out unwanted data packets; and
a second chipset module coupled with the first chipset module and configured for filtering one or more unwanted data packets without passing them to the host processor based on the information received by the first chipset module.

20. A chipset according to claim 19, wherein the first chipset module is configured to receives unwanted port information, such as unwanted universal datagram protocol port-information, from the host processor, and the second chipset module is configured to filters out data coming through such ports.

21. A chipset according to claim 19, wherein the chipset and the host processor are configured to form part of a two-part wireless communication module implementation.

22. A chipset according to claim 19, wherein the information forms part of signalling between the chipset and the host processor for indicating a request for filtering incoming broadcast packets by the chipset.

23. A chipset according to claim 19, wherein the unwanted data packets include unwanted universal datagram protocol (UDP) broadcast traffic using universal datagram protocol port-information provided by the host processor.

24. A chipset according to claim 19, wherein the information is acquired from a socket layer by the host processor and passed to the chipset.

25. A chipset according to claim 19, wherein either the first or second chipset module is configured to matches a pattern associated with ports of the unwanted data packets in relation to information contained in a header of received data packets so as to filter data packets from unwanted ports.

26. A chipset according to claim 19, wherein the information forms part of universal datagram protocol port-information located in a universal datagram protocol header.

27. A chipset according to claim 19, wherein the first chipset module is configured to receives transmissions that include broadcast or multicast type of information that form a part of the communication in the network.

28. A host processor comprising:
one or more modules configured for generating information about unwanted data packets that needs to be filtered out by a radio modem chipset without forwarding them to the host processor; and
an interface configured for providing the information to the radio modem chipset.

29. A host processor according to claim 28, wherein the information includes unwanted port information, such as unwanted universal datagram protocol port-information, so that the radio modem chipset can filter out data coming through such ports.

30. A host processor according to claim 28, wherein the host processor and the radio modem chipset are configured to form part of a two-part wireless communication module implementation.

31. A host processor according to claim 28, wherein the information forms part of signalling between the host processor and the radio modem chipset for indicating a request for filtering incoming broadcast packets by the chipset.

32. A host processor according to claim 28, wherein the one or more modules is configured to provides the information about the unwanted data packets in the form of unwanted universal datagram protocol broadcast traffic using universal datagram protocol port-information.

33. A host processor according to claim 28, wherein the one or more modules is configured to acquire the information from a socket layer and pass it to the radio modem chipset.

34. A host processor according to claim 28, wherein the information enables the radio modem chipset to match a pattern associated with ports of the unwanted data packets in relation to information contained in a header of received data packets so as to filter data packets from unwanted ports.

35. A host processor according to claim 28, wherein the information forms part of universal datagram protocol port-information located in a universal datagram protocol header.

36. A host processor according to claim 28, wherein the first chipset module is configured to receives transmissions that include broadcast or multicast type of information that form a part of the communication in the network.

37. A computer program product with a program code, which program code is stored on a machine readable carrier, for carrying out the steps of a method comprising:
receiving in a radio modem chipset information indicating that a host processor wants the radio modem chipset to filter out unwanted data packets, and
filtering one or more unwanted data packets in the chipset without passing them to the host processor based on the received information.

38. A method according to claim 1, wherein the method further comprises implementing the method via a computer program running in a processor, controller or other suitable module in one or more network nodes, points, terminals or elements in a wireless network.

39. Apparatus comprising:
means for receiving in a radio modem chipset information indicating that a host processor wants the radio modem chipset to filter out unwanted data packets; and
means for filtering one or more unwanted data packets in the chipset without passing them to the host processor based on the received information received.

40. Apparatus to claim 39, wherein unwanted port information, including unwanted universal datagram protocol port-information, is received from the host processor, and data coming through such ports is filtered out.

41. Apparatus according to claim 39, wherein the radio modem chipset and the host processor are configured to form part of a two-part module implementation.

42. A method according to claim 1, wherein the radio modem chipset receives transmissions that include broadcast or multicast type of information that form a part of the communication in the network.
